(19) United States
(12) Patent Application Publication
(10) Pub. No.: US 2010/0246046 A1
(43) Pub. Date: Sep. 30, 2010

(54) MAGNETIC TRANSFER METHOD AND MAGNETIC TRANSFER MASTER CARRIER

(75) Inventors: Masakazu NISHIKAWA, Odawara-shi (JP); Tomokazu UMEZAWA, Odawara-shi (JP); Satoshi YOSHIDA, Odawara-shi (JP); Takafumi NOGUCHI, I, Odawara-shi (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/750,024

(22) Filed: Mar. 30, 2010

(30) Foreign Application Priority Data
Mar. 31, 2009 (JP) 2009-085063

(51) Int. Cl. G11B 5/02

(52) U.S. Cl. 360/55; G9B/5.026

(57) ABSTRACT

Applying a magnetic field that varies like a single pulse from a start magnetic field to a maximum transfer magnetic field and then to an end magnetic field to a stacked body of a magnetic transfer master carrier and a perpendicular magnetic recording medium such that the time from the start magnetic field to the end magnetic field does not exceed 100 ms. The master carrier has a transfer pattern of multiple fine elements. Each element has a planar shape formed of a plurality of rectangles, each having two sides parallel to a circumferential tangent line and two sides forming an angle of 90±5° with the circumferential tangent line, arranged continuously in a track width direction. A side of the planar shape of each element intersecting the circumferential tangent line has an effective inclination corresponding to a skew angle of the read/write head.

### BACKGROUND OF THE INVENTION

1. Field of the Invention

The present invention relates to a magnetic transfer method and magnetic transfer master carrier for magnetically transferring information to a perpendicular magnetic recording medium.

2. Description of the Related Art

As a magnetic recording medium capable of recording information in high density, a perpendicular magnetic recording medium is known. The information recording area of the perpendicular magnetic recording medium is constituted by narrow tracks. Therefore, tracking servo techniques for accurately scanning a magnetic head on a narrow track width and reproducing a signal with a high S/N ratio are important for the perpendicular magnetic recording medium. In order to implement this tracking servo, it is necessary to record servo information, such as tracking servo signal, address information signal, reproducing clock signal, and the like, on the perpendicular magnetic recording medium at a regular interval as a so-called pre-format.

As for the method for pre-formatting the servo information on a perpendicular magnetic disk medium, for example, a method in which a master carrier having a pattern including a magnetic layer corresponding to servo information is brought into close contact with a perpendicular magnetic disk medium and a transfer magnetic field is applied to the stacked body to magnetically transfer the pattern of the master substrate to the perpendicular magnetic disk medium is known as described, for example, in Japanese Unexamined Patent Publication Nos. 10 (1998)-040544 and 2001-297433 (Patent Documents 1 and 2).

As for the method for applying transfer magnetic field, a perpendicular magnetization (Patent Document 1) in which a magnetic field is applied in a direction perpendicular to the surface of a perpendicular magnetic recording medium and a horizontal magnetization (Patent Document 2) in which a magnetic field is applied in a direction horizontal (parallel) to the surface of a perpendicular magnetic recording medium are known.

The magnetic transfer method by the perpendicular magnetization disclosed in Patent Document 1 is a method in which a perpendicular magnetic recording medium, initially magnetized in one direction perpendicular to the surface thereof, is brought into close contact with a master carrier having an uneven pattern and a perpendicular transfer magnetic field is applied. When the perpendicular transfer magnetic field is applied, the magnetic flux density of an area in contact with a convex portion of the master carrier becomes greater than that of the other areas so that the magnetization direction of the area in contact with the convex portion of the master carrier is aligned with the direction of the transfer magnetic field, whereby the magnetization direction is reversed from the initial magnetization direction. This results in that a magnetic pattern corresponding to the uneven pattern of the master carrier is transferred to the magnetic layer of the perpendicular magnetic recording medium.

In the mean time, the magnetic transfer method by the horizontal magnetization disclosed in Patent Document 2 is a method in which a perpendicular magnetic recording medium is brought into close contact with a master carrier having an uneven pattern and a horizontal transfer magnetic field (parallel to the surface of the disk and substantially along a circumferential direction of the disk) is applied. When the horizontal transfer magnetic field is applied, magnetic flux suction or election occurs at an edge portion of a convex portion of the master carrier and the magnetization of the area of the perpendicular magnetic recording medium in contact with the convex portion is aligned in a direction along the magnetic flux direction, whereby a pair of magnetic domains having different magnetization directions is formed with respect to one convex portion. This results in that a magnetic pattern corresponding to the uneven pattern of the master carrier is transferred to the magnetic layer of the perpendicular magnetic recording medium.

The horizontal magnetization has been known as a method for performing magnetic transfer to a longitudinal magnetic recording medium, and various different methods and apparatuses for generating a horizontal transfer magnetic field have been proposed. For example, a method in which a permanent magnet or an electromagnet extending in a radial direction is rotated one round or more with respect to the stacked body of a master carrier and a slave medium as described, for example, in Patent Document 1 and U.S. Pat. No. 6,636,371 (Patent Document 3) is commonly used. In addition, Japanese Unexamined Patent Publication No. 2001-067663 (Patent Document 4) proposes a method for generating a magnetic field along a circumferential direction by disposing an annular electromagnet on one surface or each surface of the stacked body. Further, Japanese Unexamined Patent Publication No. 2005-182920 (Patent Document 5) proposes a method for generating a magnetic field along a circumferential direction by disposing a conductor wire in the center of the stacked body and applying a current to the wire.

In a recording/reproducing device for a magnetic recording medium, a rotary actuator that moves a read/write head on the disk in an arc shape is generally used as a drive mechanism for moving the read/write head in a radial direction of the disk. Consequently, it is necessary to form each magnetic domain constituting a magnetic pattern on the disk to have a shape having a predetermined inclination with respect to a direction perpendicular to the circumferential tangent line such that a direction in which a side intersecting the track (circumferential) tangent line extends substantially corresponds to a direction of gap spacing of the head (so that azimuth loss is prevented) based on an angle formed between a direction of a long side of the read/write head and a direction perpendicular to the track (circumferential) tangent line (skew angle θ, FIG. 4).

Therefore, in order to transfer such magnetic pattern to a magnetic recording medium, a magnetic transfer master carrier needs to have a convex portion, as a pattern to be transferred formed on the surface thereof which contacts a perpendicular magnetic recording medium when magnetic transfer is performed, having a surface shape formed such that a side intersecting the circumferential tangent line has a predetermined inclination with respect to a direction perpendicular to the circumferential tangent line corresponding to the skew angle of the head.

However, the inventors of the present invention have found that, when magnetic transfer is performed on a perpendicular magnetic recording medium by horizontal magnetization, degradation of effective transfer field intensity and broadening of transfer field width occur due to the inclination of the pattern described above, leading to quality degradation of a transferred signal on a magnetic recording medium to which the signal has been transferred by magnetic transfer.

As described in Patent Document 2, if a transfer head for applying a transfer magnetic field is formed in an arc shape along the shape of a servo area, it seems that the transfer magnetic field can be made substantially perpendicular to the inclination of the pattern shape and the degradation of transfer field intensity can be prevented. According to an experiment performed by the inventors of the present invention, however, the effective field direction was substantially along a circumferential direction even though the transfer head was formed in an arc shape, and sufficient quality was not obtained for the transferred signal.

The present invention has been developed in view of the circumstances described above, and it is an object of the present invention to provide a magnetic transfer method and magnetic transfer master carrier capable of preventing quality degradation of a transferred signal on a magnetic recording medium to which the signal has been transferred by magnetic transfer.

### SUMMARY OF THE INVENTION

A magnetic transfer method of the present invention is a method for transferring a transfer pattern, which is designed for transferring desired information to a perpendicular magnetic recording medium for use in a recording/reproducing device having a rotary read/write head for scanning a disk in an arc shape intersecting concentric tracks, provided on a surface of a magnetic transfer master carrier to a perpendicular magnetic recording medium by applying a magnetic field to a stacked body of the magnetic transfer master carrier and the perpendicular magnetic recording medium tightly stacked on top of each other such that a central portion of the transfer pattern is aligned with a central portion of the perpendicular magnetic recording medium, wherein:

the transfer pattern is constituted by multiple fine elements and each element has a planar shape formed of a plurality of rectangles, each having two sides parallel to a circumferential tangent line and two sides forming an angle of 90±5° with the circumferential tangent line, arranged continuously in a track width direction in each concentrically provided track, and a side of the planar shape of each element intersecting the circumferential tangent line has an effective inclination corresponding to a skew angle of the read/write head in each track; and

the magnetic field is a circumferential magnetic field concentric to the stacked body, varied in strength like a single pulse from a start magnetic field smaller than a magnetization reversal magnetic field of the perpendicular magnetic recording medium to a maximum transfer magnetic field and then to an end magnetic field smaller than the magnetization reversal magnetic field, and applied to the stacked body such that the time from the start magnetic field to the end magnetic field does not exceed 100 ms.

The term “circumferential magnetic field” as used herein refers to a magnetic field generated circumferentially at the same time over the entire transfer area of the stacked body and does not include a case in which a horizontal magnetic field is applied to the stacked body by a magnetic field application means extending in a radial direction, such as a bar magnet, and the magnetic field application means is moved relative to the stacked body to apply the horizontal magnetic field over the entire surface.

The term “magnetization reversal magnetic field” as used herein refers to a magnetic field having strength that causes magnetization to start reversing in static magnetic hysteresis of the perpendicular magnetic recording medium (FIG. 9).

Preferably the time in which the circumferential magnetic field varies from the start magnetic field to the end magnetic field does not exceed 100 ms, and more preferably does not exceed 1 ms.

The circumferential magnetic field may be generated by an annular electromagnet disposed on at least one surface of the stacked body. Further, as the magnetic transfer master carrier and the perpendicular magnetic recording medium, those having center holes may be used and the stacked body may be formed by aligning the center holes, and the circumferential magnetic field may be generated by applying a current in a center hole of the stacked body in an axis direction substantially perpendicular to the stacked body.

A magnetic transfer master carrier of the present invention is a master carrier having a transfer pattern on a surface for transferring desired information to a perpendicular magnetic recording medium for use in a recording/reproducing device having a rotary read/write head for scanning a disk in an arc shape intersecting concentric tracks,

wherein the transfer pattern is constituted by multiple fine elements and each element has a planar shape formed of a plurality of rectangles, each having two sides parallel to a circumferential tangent line and two sides respectively forming an angle of 90±5° with the circumferential tangent line, arranged continuously in a track width direction in each of concentrically provided tracks, and a side of the planar shape of each element intersecting the circumferential tangent line has an effective inclination corresponding to a skew angle of the read/write head in each track.

In the magnetic transfer master carrier used in the magnetic transfer method of the present invention and the magnetic transfer master carrier of the present invention, it is preferable that each of the rectangles has a length in the track width direction corresponding to 1/N of the track width and each of the elements is formed by arranging N rectangles in the track width direction.

As a specific example of the desired information, servo information may be cited.

According to the magnetic transfer method of the present invention, a circumferential magnetic field, varied in strength in a short time, is applied as a transfer magnetic field to a stacked body of a magnetic transfer master carrier and a perpendicular magnetic recording medium. The magnetic transfer master carrier has a transfer pattern constituted by multiple fine elements and each element has a planar shape formed of a plurality of rectangles, each having two sides parallel to a circumferential tangent line and two sides respectively forming an angle of 90±5° with the circumferential tangent line, arranged continuously in a track width direction in each of concentrically provided tracks. This increases the effective magnetization reversal magnetic field and coercive force, and only the desired magnetization areas corresponding to edge portions of convex portions of the master carrier may be magnetized accurately. Further, the use of the magnetic transfer master carrier described above results in that, when the circumferential magnetic field of a horizontal magnetic field is applied, two sides of each of a plurality of rectangles forming the planar shape of each element interacting the circumferential tangent line becomes substantially orthogonal to the magnetic field, so that the transfer accuracy is further improved.

Further, the effective inclination of a side, intersecting the circumferential tangent line in each track, of the planar shape of each element corresponds to a skew angle of the read/write head in each track, so that the perpendicular magnetic recording medium having the transfer pattern transferred thereto allows reduction of azimuth loss of the head and detection of a high S/N signal.

Still further, as the circumferential magnetic field, a magnetic field varied in strength like a single pulse from a start magnetic field smaller than a magnetization reversal magnetic field of the perpendicular magnetic recording medium to a maximum transfer magnetic field and then to an end magnetic field smaller than the magnetization reversal magnetic field is applied such that the time from the start magnetic field to the end magnetic field does not exceed 100 ms, which allows an excellent quality signal to be obtained from the perpendicular magnetic recording medium after the magnetic transfer.

As the conventional transfer magnetic field, a DC magnetic field, in which a constant magnetic field is applied continuously (a little over one second) to the stacked body, or an AC magnetic filed, in which a magnetic field is applied by periodically varying the strength in a predetermined direction, has been employed. But neither of them can provide a satisfactory transfer signal quality. It would be attributed to the fact that the magnetic layer of a magnetic recording medium is not necessarily uniform, having a portion where the coercive force is small, and the magnetization is partly changed to the direction of the magnetic flux not only at an area corresponding to an edge portion of the convex portion of the master carrier but also at an area corresponding to a concave portion where the magnetic flux density is small, resulting in a poor degree of separation of the transfer pattern.

On the other hand, as in the present invention, if magnetic transfer is performed by applying a single pulse like magnetic field varied in strength in a short time only once, the dynamic coercive force is increased even in a place of the magnetic layer of the magnetic recording medium where static coercive force is small by the dynamic magnetic properties, whereby the magnetization transfer is prevented and transfer signal quality may be improved.

As described above, according to the magnetic transfer method of the present invention, a magnetic pattern precisely corresponding to an uneven pattern shape formed on a master carrier may be magnetically transferred to a perpendicular magnetic recording medium accurately, whereby signal characteristics of the perpendicular magnetic recording medium are improved and, in particular, when the transfer pattern is servo information, an excellent tracking servo function may be obtained.

That is, a magnetic transfer master carrier having a favorable pattern for a magnetic field oriented in a circumferential direction is used, and magnetic transfer is performed by applying the circumferential magnetic field for a short time not greater than 100 ms, so that a preformatted perpendicular magnetic recording medium having favorable transfer accuracy may be produced in a very short time.

The magnetic transfer master carrier of the present invention is a master carrier which is, in particular, used preferably in the magnetic transfer method of the present invention described above. Each of multiple fine elements constituting the transfer pattern has a planar shape formed of a plurality of rectangles, each having two sides parallel to a circumferential tangent line and two sides respectively forming an angle of 90±5° with the circumferential tangent line, arranged continuously in a track width direction in each of concentrically provided track, and when a horizontal magnetic field is applied, each of two sides intersecting the circumferential tangent line forms an angle of 90±5° with the magnetic field, that is, becomes substantially orthogonal to the magnetic field, so that the transfer accuracy may be improved.

### BRIEF DESCRIPTION OF THE DRAWINGS

FIG. 1 is a plan view of a magnetic transfer master carrier according to an embodiment of the present invention.

FIG. 2 is a partially enlarged perspective view of the master carrier shown in FIG. 1.

FIG. 3 illustrates a slave medium of perpendicular magnetic disk medium and a magnetic head.

FIG. 4 is a partially enlarged schematic view of the perpendicular magnetic disk medium and magnetic head shown in FIG. 3.

FIG. 5A illustrates a planar shape of one element constituting a transfer pattern (on the outer circumferential side).

FIG. 5B illustrates a planar shape of one element constituting a transfer pattern (on the inner circumferential side).

FIG. 5C illustrates a rectangle constituting one element.

FIGS. 6A to 6C illustrate a magnetic transfer process.

FIG. 7 is a sectional view illustrating a transfer magnetic field application process.

FIG. 8 illustrates a waveform for defining a single pulse transfer magnetic field.

FIG. 9 comparatively illustrates dynamic and static magnetization curves of a perpendicular magnetic recording medium.

FIG. 10 is a perspective view of a relevant part of a transfer magnetic field generation unit according to a first embodiment.

FIG. 11 illustrates a circular magnetic field generated by transfer magnetic field generation unit shown in FIG. 10.

FIG. 12 illustrates an example of a current circuit employed in a magnetic transfer device.

FIG. 13 is a perspective view of a relevant part of a transfer magnetic field generation unit according to a second embodiment.

### DESCRIPTION OF THE PREFERRED EMBODIMENTS

Hereinafter, embodiments of the present invention will be described with reference to the accompanying drawings.

### (Magnetic Transfer Master Carrier)

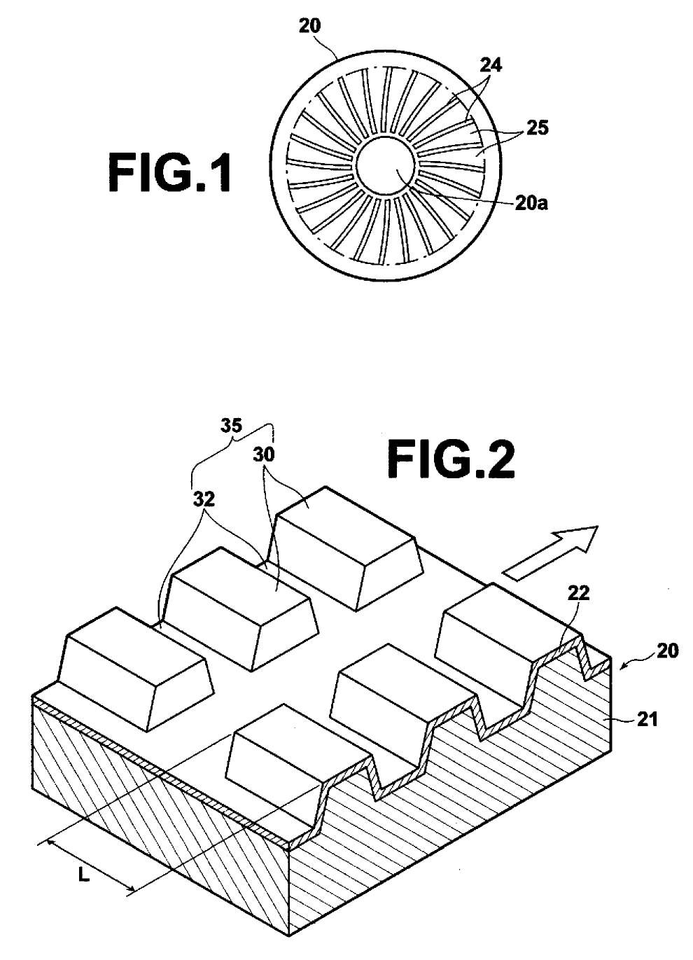

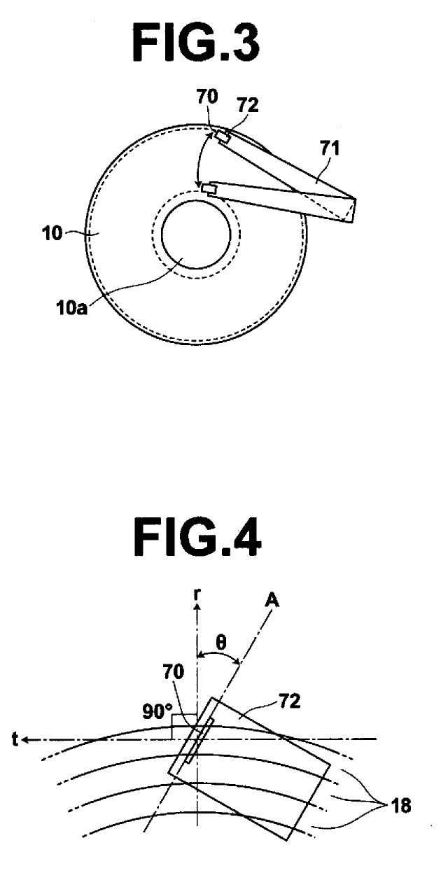

FIG. 1 is a plan view of magnetic transfer master carrier 20 according to an embodiment of the present invention, and FIG. 2 is a partially enlarged perspective view thereof. FIGS. 3 and 4 illustrate perpendicular magnetic recording medium 10, which is a medium that receives magnetic transfer from master carrier 20.

As illustrated in FIGS. 1 and 2, magnetic transfer master carrier 20 of the present embodiment is formed in a disk having center hole 20a and has uneven pattern 35 constituted by a plurality of concave portions 32 and convex portions 30 according to information to be transferred to a perpendicular magnetic recording medium on an annular area of one surface excluding inner and outer circumferential portions.

Perpendicular magnetic recording medium 10, which is a magnetic transfer receiving medium, is a medium for use in a recording/reproducing device having rotary drive read/write head 70 that scans on the disk in an arc shape intersecting concentric tracks. Uneven pattern 35 is a transfer pattern for transferring desired information, such as servo information and the like, to perpendicular magnetic recording medium 10.

Read/write head 70 is a so-called composite head, including a write head and a read head. Read/write head 70 is mounted in head slider 72 and attached to the tip of actuator arm 71. Actuator arm 71 is driven by a not shown voice coil motor to drive the head in an arc shape intersecting tracks in the arrow directions in FIG. 3. When, for example, head slider 72 is moved on the outer circumferential side of the perpendicular magnetic recording medium, the head slider is disposed inclined with respect to record track 11, as shown in FIG. 4. Here, skew angle θ of the head refers to an angle formed between direction A of a long side of read/write head 70 and direction r (which is a radial direction of the disk) which is perpendicular to track (circumferential) tangent line t.

Master carrier 20 of the present embodiment has servo area 24 and data area 25 alternately formed in a track (circumferential) direction, and uneven pattern 35 according to servo information is formed in servo area 24. Servo area 24 is formed in an arc shape according to the arc shaped trajectory of the head of the recording/reproducing device.

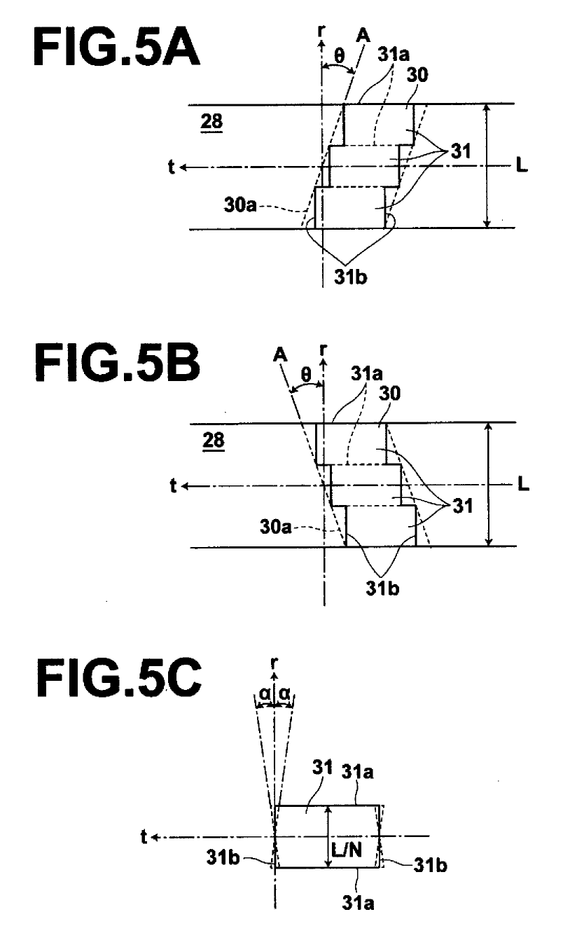

A planar shape of multiple fine elements (convex portions 30) constituting uneven pattern 35 formed in a servo area of master carrier 20 will be described with reference to FIGS. 5A to 5C. The planar shape of convex portion 30 is important because it is an area that contacts a magnetic recording medium when magnetic transfer is performed and contributes greatly to the transfer accuracy.

FIG. 5A illustrates the planar shape of convex portion 30 on the outer circumferential side and FIG. 5B illustrates the planar shape of convex portion 30 on the inner circumferential side. As illustrated in FIGS. 5A and 5B, the planar shape of convex portion 30 is a shape constituted by a plurality of rectangles 31, each formed of two sides 31a parallel to circumferential tangent line t and two sides 31b that form an angle of 90±5° with circumferential tangent line t, continuously arranged in a track width direction in each track 28, and the effective inclination of side 30a intersecting circumferential tangent line t corresponds to skew angle θ of read/write head in each track 28. The planar shape of convex portion 30 is a shape enclosed by the solid line in FIG. 5A or 5B, but the effective inclination at the time of transfer is side 30a indicated by the dotted line, and the inclination of a magnetic domain formed on perpendicular magnetic recording medium 10 with respect to circumferential tangent line t is an inclination along side 30a.

FIG. 5C depicts the shape of rectangle 31 in greater detail. The angle of each of two sides 31b of rectangle 31 formed with circumferential tangent line t may be 90±5°, that is, each side 31b may have an inclination α within a range of 5° (α≦5°) with respect to direction r perpendicular to circumferential tangent line t. Here, it is more preferable that α≦3°. As illustrated in FIGS. 5A to 5C, it is preferable that the length of rectangle 31 in a track width direction is 1/N of track width L. That is, it is preferable that the planar shape of convex portion 30 is a shape in which N rectangles 31 with a length in track width L of L/N are continuously arranged in the track width direction. Here, N is an integer not less than two, and in the examples of FIGS. 5A to 5C, N is three.

As illustrated in FIG. 2, master carrier 20 basically includes base member 21 and magnetic layer 22 formed on the surface of base member 21. Base member 21 has, on a surface thereof, a fine uneven pattern constituted by convex portions 30 and concave portions 32, and magnetic layer 22 is uniformly formed over the entire surface layer of the fine uneven pattern. In the present embodiment, magnetic layer 22 is also formed on the surface of concave portion 32 for reasons of easier manufacture, but the magnetic layer is required to be formed only on the surface of convex portion 30 and not on the surface of concave portion 32. Preferably, master carrier 20 further includes a protection layer, a lubricant layer, an underlayer, and the like to be described later.

As the master carrier, a carrier having a reverse uneven pattern to that described above on a base member, in which a magnetic layer is mounted on the surface of a concave portion and the surface of the base member is formed flat, may be used. Alternatively, a carrier having a base member with a planar surface on which a magnetic bit is provided at an area corresponding to a convex portion described above and an uneven pattern is formed on the surface by the arrangement of the magnetic bits, may be used. The magnetic layer mounted on the surface of a concave portion in the former case or each magnetic bit in the latter case corresponds to the “element” constituting a transfer pattern of the present invention, and it is important that the planar shapes thereof are formed identical to that of convex portion 30.

Base member 21 may be manufactured using any known material, including glass, synthetic resin such as polycarbonate, metal such as nickel and aluminum, silicon, carbon, and the like.

There is not any specific restriction on the material of magnetic layer 22 and may be selected from known materials according to the intended use. Preferable materials include, for example, Fe, Co, Ni, FeCo, FeNi, CoNi, CoNiP, FePt, CoPt, NiPt, and the like. These materials may be used independently or in combination of two or more of them. There is not any specific restriction on the thickness of magnetic layer 22 and may be selected as appropriate for the intended use, but normally it is about 5 to 30 nm. Further, there is not any specific restriction on the method for forming magnetic layer 22, and the layer may be formed using any known method, such as sputtering method, electrodeposition method, and the like.

A crystal orientation layer for the orientation of the magnetic layer and a soft magnetic underlayer may be formed, as appropriate, between base member 21 and magnetic layer 22. In particular, the soft magnetic underlayer may be formed in a single layer or in plural layers.

A protection layer is formed on the surface of master carrier 20 in order to improve mechanical property, frictional property, and weatherability. As the material of the protection layer, a hard carbon film is preferably used and inorganic carbon, diamond-like carbon or the like formed by sputtering method may be used. A layer of lubricant agent (lubricant layer) may further be formed on the hard protection layer. As for such type of lubricant agent, a fluorine system resin, such as perfluoropolyether (PFPE) or the like, is generally used.

### (Master Carrier Manufacturing Method)

An original sheet of silicon wafer (Si substrate) having a smooth surface is provided, then an electron beam resist is applied on the original sheet by spin coating method to form a resist layer, and a baking process (pre-baking) is performed.

Then, a not shown electron beam exposure system having a high-precision rotation stage or X-Y stage is provided and the original sheet is set on the stage. While rotating the original sheet, an electron beam modulated according to a servo signal is emitted to exposure write (perform electron beam writing for) a predetermined pattern substantially over the entire surface of the resist layer. For example, a pattern corresponding to a servo signal extending in the radial direction from the rotation center to each track is exposure written on an area corresponding to each frame on circumferences.

The resist layer is developed to remove an exposed (written) portion and a covering layer is formed by the remaining resist layer. The covering layer serves as the mask in the next process (etching process). As the resist applied to the substrate, either the positive or negative type may be used. It is noted here that the exposed (written) pattern is reversed between the positive and negative types. After the development process, a baking process (post-baking) is performed to improve the adhesion between the resist layer and original sheet.

Then, a portion of the original sheet not covered with the resist layer is removed (etched) by a predetermined depth from the surface. Here, anisotropic etching for minimizing undercut (side etch) is desirable, and as such anisotropic etching, reactive ion etching (RIE) is preferably used.

Next, the resist layer is removed. As the method for removing the resist layer, ashing can be adopted as a dry method, and a removal method by a stripping solution can be adopted as a wet method. By the ashing process, an original master having thereon a reverse shape of a desired uneven pattern is produced.

Thereafter, a conductive layer is formed on the surface of the original master with a uniform thickness. As the method for forming the conductive layer, various metal deposition methods, including PVD (Physical Vapor Deposition), CVD (Chemical Vapor Deposition), sputtering, and ion-plating, may be used.

Formation of one layer of conductive film may provide an advantageous effect of uniform metal electrodeposition in the next process (electroforming). As the conductive layer, a Ni-based film is preferable, since it can be formed easily and is rigid.

Next, a metal plate (Ni in this case) of a desired thickness is stacked on the surface of the original master by electroforming (reversal plate forming process). The process is performed by putting the original master in an electrolyte solution of an electroforming system and applying a current between the original master, acting as an anode, and a cathode. The density and pH of the electrolyte solution, current application method, and the like are required to be such that the metal plate (base member 21) is stacked under optimum conditions so as not to have any distortion.

Then the original master having the metal plate stacked thereon is taken out of the electrolyte solution and soaked in the deionized water in a separation tank (not shown). In the separation tank, the metal plate is separated from the original master, whereby base member 21 having an uneven pattern reversed from that of the original master is obtained.

Then, magnetic layer 22 is formed on the uneven surface of base member 21. The material of the magnetic layer is, for example, FeCo. Preferably, the thickness of magnetic layer 22 is in the range from 10 to 320 nm, more preferably in the range from 20 to 300 nm, and most preferably in the range from 30 to 100 nm. Magnetic layer 22 is formed by sputtering using a target of the material described above.

Thereafter, the inside diameter and the outside diameter of base member are punched out with predetermined sizes. This completes the process of producing master carrier 20 having an uneven pattern on which magnetic layer 22 is provided.

The uneven pattern on the surface of master carrier 20 constitutes a servo pattern. Although not shown, a protection film (protection layer) of diamond-like carbon or the like may be provided on magnetic layer 22 on the surface of master carrier 20, and further a lubricant layer may be provided on the protection film.

The purpose of the protection layer is to protect magnetic layer 22 from damage when master carrier 20 is brought into close contact with magnetic recording medium 10, thereby preventing master carrier 20 from being unusable as the master carrier. The lubricant layer has an advantageous effect of preventing damage due to friction when master carrier 20 and magnetic recording medium 10 are brought into close contact with each other, thereby improving the durability.

More specifically, a desirable configuration is that a carbon film with a thickness of 2 to 30 nm is formed as the protection layer, and a lubricant layer is formed thereon. Further, in order to improve the adhesion between magnetic layer 22 and the protection layer, an adhesion enhancing layer of Si or the like may be formed before the protection layer.

### (Perpendicular Magnetic Recording Medium)

Perpendicular magnetic recording medium 10 shown in FIG. 3 is a medium including a disk-shaped substrate having a magnetic layer on one or both surfaces, a specific example of which is a high-density hard disk or the like. Magnetic recording medium 10 includes non-magnetic substrate 11, such as glass or the like, on which a soft magnetic layer (soft magnetic underlayer, SUL), non-magnetic layer (intermediate layer), and magnetic layer (perpendicular magnetic recording layer) 12 are stacked in this order, and the magnetic layer is covered with a protection layer and a lubricant layer.

The disk-shaped substrate is made of a non-magnetic material, such as glass, aluminum, or the like, and the soft magnetic layer is formed thereon first, and then the non-magnetic layer and magnetic layer are formed.

The soft magnetic layer is advantageous for stabilizing the state of perpendicular magnetization of the magnetic layer and improving the sensitivity for recording and reproducing operations. Preferably, the soft magnetic layer is formed of a soft magnetic material, such as CoZrNb, FeTaC, FeZrN, FeSi alloy, FeAl alloy, FeNi alloy such as permalloy, FeCo alloy such as permendur, or the like. The soft magnetic layer has magnetic anisotropy in a radial direction (in a radial fashion) from the center of the disk to the outside.

Preferably, the thickness of the soft magnetic layer is in the range from 20 to 2000 nm, and more preferably in the range from 40 to 400 nm.

The non-magnetic layer is provided to increase the perpendicular magnetic anisotropy of the magnetic layer to be formed later. Preferably, the non-magnetic layer is formed of Ti (titanium), Cr (chromium), CrTi, CoCr, CrTa, CrMo, NiAl, Ru (ruthenium), Pd (palladium), Ta, Pt, or the like. The non-magnetic layer is formed by sputtering using one of the materials described above. Preferably, the thickness of the non-magnetic layer is in the range from 10 to 150 nm, and more preferably in the range from 20 to 80 nm.

The magnetic layer is formed of a perpendicular magnetization film (axes of easy magnetization in the magnetic film are mainly oriented perpendicular to the substrate), and information is recorded on the magnetic layer. Preferably, the magnetic layer is formed of Co (cobalt), Co alloys (CoPtCr, CoCr, CoPtCrTa, CoPtCrNbTa, CoCrB, CoNi, or the like), Co alloy-SiO₂, Co alloy-TiO₂, Fe, Fe alloys (FeCo, FePt, FeCoNi, or the like), or the like. Each of these materials has a high magnetic flux density and may have perpendicular magnetic anisotropy by controlling a film forming condition or the composition. The magnetic layer is formed by sputtering using one of the materials described above. Preferably, the thickness of the magnetic layer is in the range from 10 to 500 nm, and more preferably in the range from 20 to 200 nm.

### (Magnetic Transfer Method)

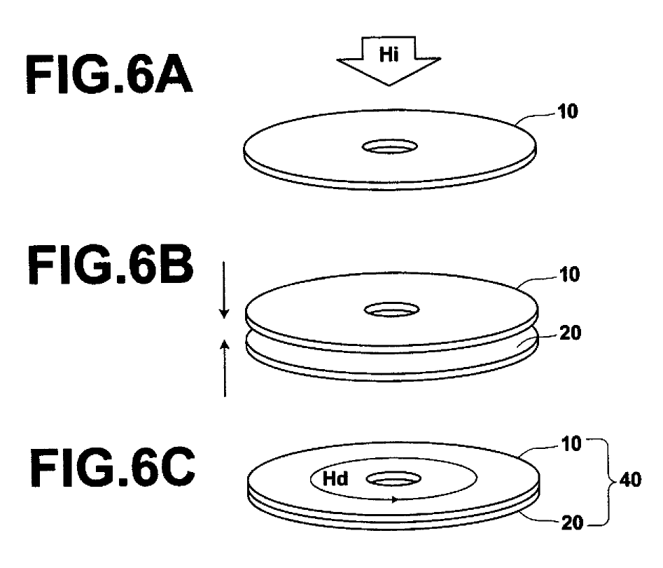

A magnetic transfer method according to an embodiment of the present invention in which a transfer pattern is transferred to a perpendicular magnetic recording medium using the aforementioned magnetic transfer master carrier will now be described. FIGS. 6A to 6C illustrate the magnetic transfer process.

### <Initial Magnetization Step>

As illustrated in FIG. 6A, initial magnetization (DC magnetization) of perpendicular magnetic recording medium 10 is performed by generating initialization magnetic field Hi by an apparatus (not shown magnetic field application means) capable of applying a magnetic field in a direction perpendicular to the surface of perpendicular magnetic recording medium 10. More specifically, the initial magnetization is performed by generating a magnetic field, as initialization magnetic field Hi, having strength greater than coercive force Hc of magnetic recording medium 10. Magnetic layer 12 of magnetic recording medium 10 is initially magnetized in a direction perpendicular to the disk surface by the initial magnetization. When the magnetic field application area is smaller than the disk surface, the initial magnetization step may be performed by moving magnetic recording medium 10 relative to the magnetic field application means. In principle, the initial magnetization step is not necessarily required, but the initial magnetization may provide a better reproduced signal from the perpendicular magnetic recording medium after magnetic transfer.

### <Contacting Step>

Next, magnetic transfer master carrier 20 is brought into close contact with perpendicular magnetic recording medium 10 after the initial magnetization step. In the contacting step, the surface of master carrier 20 on which an uneven pattern is formed is contacted to the surface of magnetic recording medium 10 on which magnetic layer 12 is formed by a predetermined pressing force.

A cleaning step (varnishing, or the like) for removing a microscopic protrusion or a dust is performed, as required, on magnetic recording medium 10 by a glide head, a grinder, or the like before being brought into close contact with master carrier 20.

There may be two cases for the contacting step, in one of which master carrier 20 is brought into close contact with only one surface of magnetic recording medium 10, as illustrated in FIG. 6B, and in the other of which master carriers are brought into close contact with a magnetic recording medium having a magnetic layer (recording layer) on each surface from both sides. The latter case may provide an advantageous effect that the magnetic transfer can be performed for two surfaces at the same time.

### <Transfer Magnetic Field Application Step>

Then, with respect to stacked body 40 of perpendicular magnetic recording medium 10 and master carrier 20 brought into close contact with each other, circumferential magnetic field Hd along a circumference of the stacked body is applied, as the transfer magnetic field, whereby magnetic information corresponding to the transfer pattern of master carrier 20 is transferred to perpendicular magnetic recording medium. Although the method for generating circumferential magnetic field Hd will be described later, circumferential magnetic fields Hd are concentrically generated on inner and outer circumferences of a perpendicular magnetic recording medium and master carrier 20 at the same time, and magnetic transfer is carried out by the penetration of magnetic flux generated by circumferential magnetic field Hd into magnetic recording medium 10 and master carrier 20.

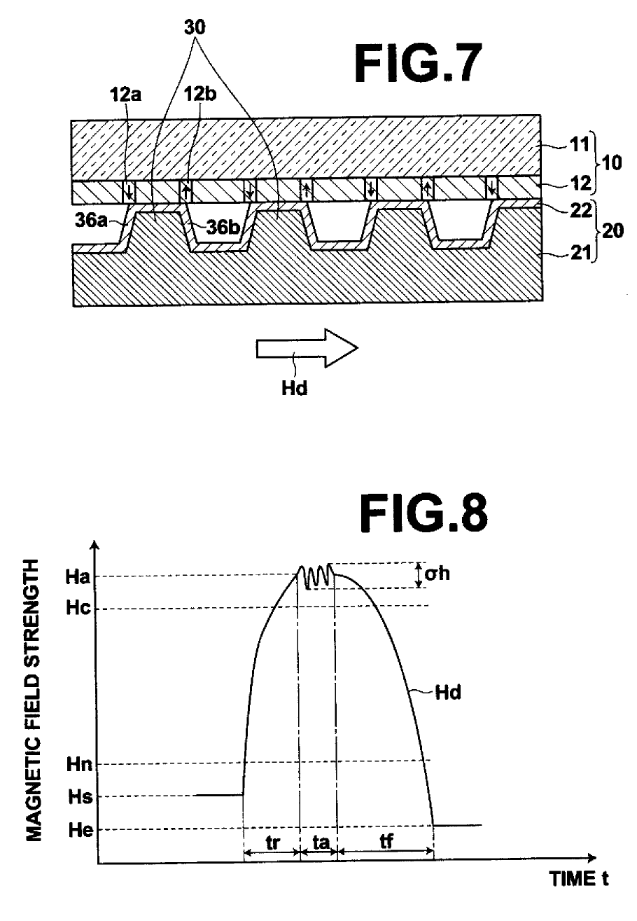

FIG. 7 is a sectional view of stacked body 40 taken along a circumferential direction, schematically illustrating the transfer magnetic field when circumferential magnetic field Hd is applied to stacked body 40. When circumferential magnetic field Hd is applied, magnetic flux suction and ejection occur at edge portions 36a, 36b of convex portion 30 of master carrier 20, which causes the magnetization directions of areas 12a, 12b of magnetic layer 12 of perpendicular magnetic recording medium 10 closely contacting edge portions 36a, 36b of convex portion 30 to be aligned in the directions along the magnetic flux orientations, whereby a pair of magnetic domains having different orientations are formed for each convex portion 30. This results in that a magnetic pattern corresponding to the uneven pattern of the master carrier is transferred to the perpendicular magnetic recording medium. Over the entire area of master carrier 20 of the present invention, each of fine elements (here, convex portions 30) forming an uneven pattern has a planar shape in which two sides intersecting a circumferential direction of the carrier are substantially orthogonal to the horizontal magnetic field (circumferential magnetic field). This causes the magnetic flux to be concentrated sharply at edge portions 36a and 36b of convex portion 30, whereby transfer accuracy may be improved.

Circumferential magnetic field Hd is a magnetic field having strength varied like a single pulse from start magnetic field Hs smaller than magnetization reversal magnetic filed Hn of perpendicular magnetic recording medium 10 to maximum transfer magnetic field Ha and then to end magnetic field He smaller than magnetization reversal magnetic filed Hn, which is applied such that the time from start magnetic field Hs to end magnetic field He (time in which the strength varies from start magnetic field Hs to end magnetic field He) does not exceed 100 ms.

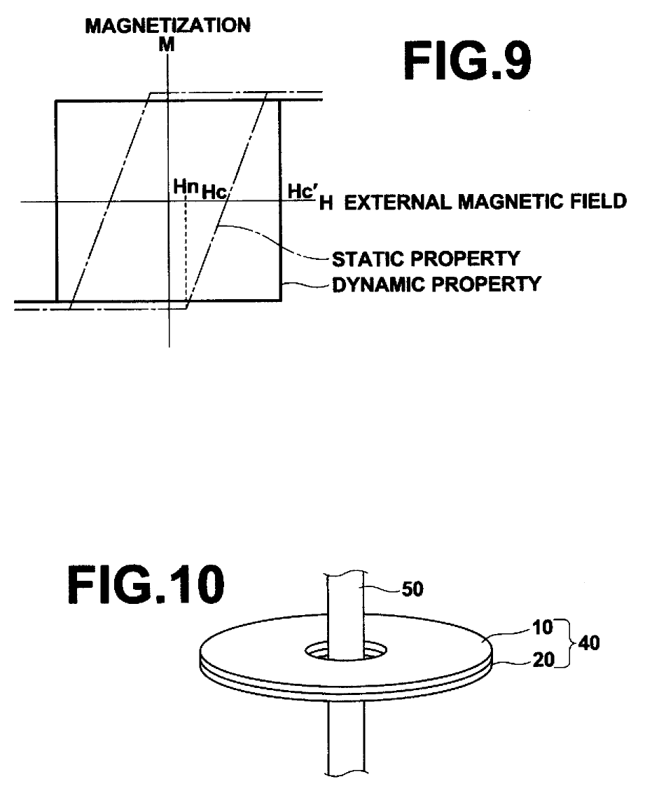

FIG. 8 illustrates an example transfer magnetic field (circumferential magnetic field) Hd varied like a single pulse. As illustrated in FIG. 8, circumferential magnetic filed Hd whose strength increases from start magnetic field Hs smaller than magnetization reversal magnetic field Hn (static property in FIG. 9), reaches maximum transfer magnetic field Ha once, and then decreases to end magnetic field He smaller than magnetization reversal magnetic field Hn. A transfer method of the present invention performs magnetic transfer by applying such a single pulse like circumferential magnetic field only once.

Single pulse like circumferential magnetic field Hd is represented by the total of time tr in which the strength increases from start magnetic field Hs to transfer field Ha, time to during which the strength is maintained at transfer field Ha, and time tf in which the strength decreases from transfer field Ha to end magnetic field He, and the time duration (pulse width) from the start point is to end point to does not exceed 100 ms. Magnetic transfer is completed by one time application of single pulse like circumferential magnetic field Hd. Preferably, the time duration is not greater than 1 ms, and more preferably not greater than 0.1 ms, but the time duration and maximum transfer magnetic field Ha are determined based on the magnetic properties (in particular, coercive force Hc) of perpendicular magnetic recording medium 10. FIG. 8 shows that maximum transfer magnetic field Ha is greater than static coercive force Hc, but the strength of maximum transfer magnetic field Ha may be in the range from 60 to 130% of static coercive force Hc of magnetic layer 12 of perpendicular magnetic recording medium 10, and more preferably in the range from 70 to 120%.

Magnetic field variation oh during time to in which the strength is maintained at maximum transfer magnetic field Ha is within ±5% of transfer magnetic field Ha. Temporal magnetic field variation from start magnetic field Hs to transfer magnetic field Ha and temporal magnetic field variation from transfer magnetic field Ha to end magnetic field He may be determined arbitrarily.

FIG. 9 schematically illustrates a static hysteresis characteristic (dot-dash line) and a dynamic hysteresis characteristic (solid line) of a magnetic layer used for magnetic recording layer of a perpendicular magnetic recording medium. Magnetic characteristics of a magnetic layer of a magnetic recording medium vary largely by the scanning speed (sweep speed) of an external magnetic field. In FIG. 9, the static characteristic indicated by the dot-dash line represents a hysteresis loop when the sweep speed is sufficiently slow and as the sweep speed is increased, the shape of the hysteresis loop tends to approach a rectangular shape as indicated by the solid line and the squareness ratio tends to increase. In the dynamic characteristic, coercive force Hc′ becomes greater in comparison with static coercive force Hc. Likewise, magnetization reversal magnetic field becomes greater in comparison with static magnetization reversal magnetic field Hn. As the hysteresis loop approaches a rectangle, the magnetization reversal magnetic field approaches to coercive force Hc′.

Application of single pulse like magnetic field with a pulse width not greater than 100 ms described above corresponds to variation of the magnetic field with a fast sweep speed, and when a single pulse like magnetic field is applied, the magnetization characteristic of the magnetic layer of magnetic recording medium 10 becomes dynamic and the coercive force and magnetization reversal magnetic field become large. Accordingly, when the magnetic field is applied, the alignment accuracy of magnetization in the direction of the magnetic flux is enhanced only at a portion where the magnetic flux is strengthened by an edge portion of a convex portion, and as a consequence the quality of a transferred signal is improved.

For example, a preformatted perpendicular magnetic recording medium produced by transferring a servo signal using the transfer method according to an embodiment of the present invention described above is incorporated in a magnetic recording/reproducing device, such as a hard disk, and used. This allows a high density magnetic recording/reproducing device having favorable recording/reproducing characteristics with high servo accuracy to be obtained.

### (Circumferential Magnetic Field Generation Method)

Methods for generating a circumferential magnetic field, i.e. a transfer magnetic field, will now be described.

A first method for generating a circumferential magnetic field is a method in which conductor wire 50 is put through the center hole of stacked body 40 of magnetic recording medium 10 and master carrier 20 brought into close contact with each other, with center hole 10a being aligned with center hole 20a, so as to be placed in the center of the hole as illustrated in FIG. 10 and a current is applied to conductor wire 50, thereby generating a circumferential magnetic field around conductor wire 50. Conductor wire 50 is put through the center hole of stacked body 40 so as to be substantially perpendicular to stacked body 40.

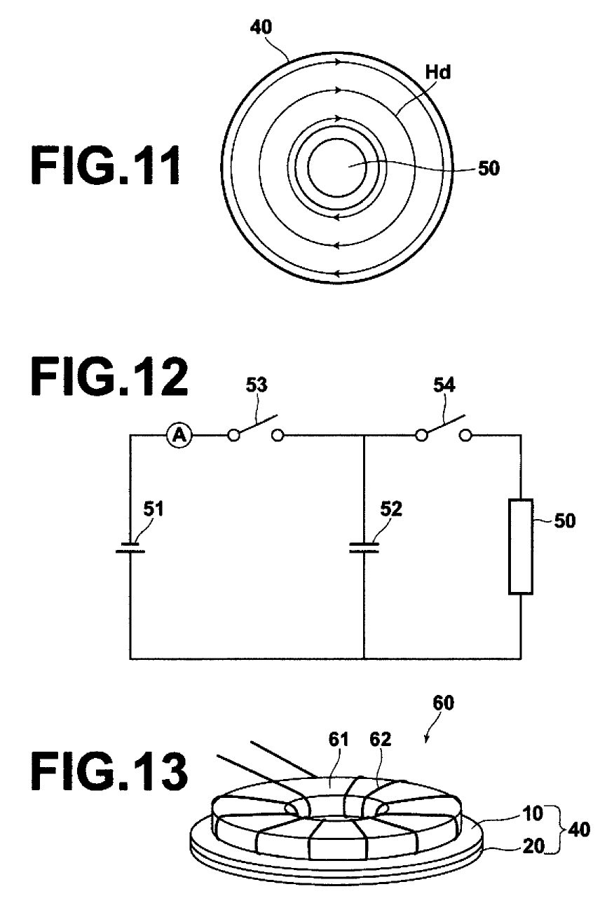

As schematically illustrated in FIG. 11, the application of a current to conductor wire 50 causes circumferential magnetic field Hd=I/2πr (T: current, r: distance from current center) to be generated. The value of current to be applied to conductor wire 50 is determined based on the size of magnetic recording medium 10, magnetic recording characteristics (e.g., coercive force Hc) of the magnetic layer, and the like.

Conductor wire 50 is connected to a current circuit having power source 51, capacitor 52, and switches 53, 54 shown in FIG. 12. Capacitor 52 is charged by closing switch 53 while opening switch 54. Thereafter, when switch 54 is closed to apply a current to conductor wire 50, the charges stored in capacitor 52 are discharged at once, whereby a large current may be applied instantaneously to conductor wire 50. Provision of capacitor 52 having a sufficient capacity allows the use of power source 51 of relatively small output. Instantaneous application of a large current to conductor wire 50 may generate a circumferential magnetic field whose strength varies in a short time in a pulse like manner.

A second method for generating a circumferential magnetic field is a method that uses annular electromagnet 60 having ring shaped core member 61 and coil 62 wound around the surface of core member 61, as illustrated in FIG. 13. A circumferential magnetic field is generated by placing annular electromagnet 40 on one side or each side of stacked body 40 and applying a current to coil 62.

As annular electromagnet 60, an annular electromagnet having a size comparable to the track area (transfer pattern area) or greater than that is used. Use of such large size electromagnet may apply a uniform magnetic field to stacked body 40. Coil 62 is connected to a not shown pulse power supply and a current is applied such that a single pulse like magnetic field having the characteristic shown in FIG. 8 is generated. The magnetic field strength applied to stacked body 40 from annular electromagnet 60 can be controlled by adjusting the magnitude of the current applied to annular electromagnet 60 and the spacing between annular electromagnet 60 and stacked body 40.

Use of such annular electromagnet 60 allows the magnetic strength to be uniform at each track position. It is noted that an air gap solenoid coil may be used as the annular electromagnet.

### EXAMPLES

Hereinafter, examples of the present invention will be described. It should be appreciated that the present invention is not limited to the examples described below.

Methods for manufacturing a master carrier and a perpendicular magnetic recording medium used in Examples 1 to 11 and Comparative Examples 1 to 7 will be described.

### (Manufacture of Master Carrier)

An electron beam resist was applied on an 8 inch Si (silicon) wafer (substrate) by spin coating method with a thickness of 80 nm. Then, the resist on the substrate was exposed using a rotary electron beam exposure device, and the resist after exposure was developed to produce a resist Si substrate having an uneven pattern.

Thereafter, using the resist as a mask, a reactive ion etching was performed on the substrate, whereby a concave portion of the uneven pattern was etched. After the etching, the resist remaining on the substrate was washed with a soluble solvent and removed. After the removal, the substrate was dried to use it as an original master for preparing a master carrier.

The pattern used in Example 1 includes a servo section. With respect to the servo section, the reference signal length is 60 nm, number of sectors is 128, and includes preamble (38 bits)/SAM (6 bits)/Sector Code (16 bits)/Cylinder Code (32 bits)/Burst pattern. The SAM section is “001010”, a binary conversion is used for the sector and a gray conversion is used for the cylinder. Burst section is general 4 bursts (16 bits for each burst) Manchester conversion is used for SAM section and post conversion address section.

A Ni (nickel) conductive film was formed on the original master with a thickness of 20 nm. The original master after the conductive film was formed thereon was immersed in nickel sulfamate bath and a Ni film was formed by electrodeposition method with a thickness of 220 μm. Thereafter, the Ni film was separated from the original master and washed to obtain a Ni master carrier intermediary body.

A magnetic layer of Fe70 at % Co30 at % was formed on the master carrier intermediary body with a thickness of 50 nm by sputtering method under an argon pressure of 0.12 Pa to obtain a master carrier.

A plurality of magnetic transfer master carriers were produced as Examples 1 to 8 and Comparative Example 1 to 3, some of which have the same angle formed between a side of a convex portion of the uneven pattern and a direction perpendicular to the circumferential magnetic field and the other of which have different angles.

### (Measurement of Angle Between Side of Convex Planar Shape and Direction Perpendicular to Circumferential Magnetic Field)

A high resolution observation was performed on an uneven pattern corresponding to magnetic information (servo information) of a master carrier at angular position of sector number 0 with respect to burst pattern of innermost circumference (radius of 20 mm) and outermost circumference (radius of 32 mm) using a scanning electron microscope (FE-SEM 5800, Hitachi Ltd.)

Based on the observation results, an angle between a side of convex portion planar shape and a direction perpendicular to the circumferential magnetic field (angle α in FIG. 5C) was measured. The measurement was made for 10 burst patterns and an average value was calculated. A comparison was made between average values of the innermost and outermost circumferences and the one greater than the other was defined absolute maximum angle α.

In the resist exposure writing using a rotary electron beam exposure device in the process of manufacturing Examples and Comparative Examples of magnetic transfer master carrier, when writing an area corresponding to a convex portion of master carrier, the planar surface of the convex portion was written by writing a plurality of rectangles. When the writing was performed, the angle between the sides of the rectangles intersecting a track direction and a direction perpendicular to a circumferential direction was varied to produce master carriers having various angles α shown in Table 1.

For example, the master carrier of Example 1 was evaluated to have average values of 2.7 and 2.9° for inner and outer circumferences respectively, so that 2.9° was selected as α.

For each of master carriers of Examples 2 to 11 and Comparative Examples 1 to 7, angle α was calculated in the same manner as described above as shown in Table 1 below.

### (Manufacture of Perpendicular Magnetic Recording Medium)

A soft magnetic layer, a first non-magnetic orientation layer, a second non-magnetic orientation layer, a magnetic recording layer, and a protection layer were formed in this order on a 2.5 inch glass substrate by sputtering method. Further, a lubricant layer was formed on the protection layer by dip method.

CoZrNb was used as the material of the soft magnetic layer. The thickness of the soft magnetic layer was 100 nm. A glass substrate was placed opposite to the CoZrNb target and Ar gas was introduced to a pressure of 0.6 Pa, and film forming was performed with DC 1500 W.

As the first non-magnetic orientation layer, a Ti film with a thickness of 5 nm was formed, and as the second non-magnetic orientation layer, a Ru film with a thickness of 6 nm was formed. For the first non-magnetic orientation layer, a Ti layer was formed to a thickness of 5 nm by placing the substrate opposite to a Ti target, introducing Ar gas to a pressure of 0.5 Pa, and discharging at DC 1000 W. After the first non-magnetic orientation layer, the Ru second non-magnetic orientation layer was formed to a thickness of 6 nm by placing the substrate opposite to a Ru target, introducing Ar gas to a pressure of 0.8 Pa, and discharging at DC 900 W.

As the magnetic recording layer, a CoCrPtO film with a thickness of 18 nm was formed by placing substrate opposite to a CoCrPtO target, introducing Ar gas with 0.06% of O₂ to a pressure of 14 Pa, and discharging at DC 200 W.

After the magnetic recording layer, a C (carbon) protection layer (4 nm) was formed by placing the substrate opposite to a C target, introducing Ar gas to a pressure of 0.5 Pa, and discharging at DC 1000 W. The coercive force of the recording medium was 334 kA/m (4.2 kOe). Further, PFPE lubricant agent was applied to the medium with a thickness of 2 nm by dip method. A perpendicular magnetic recording medium was prepared in the manner described above.

### Example 1

A magnetic transfer method of Example 1 was performed in the following steps using a master carrier having a pattern shape with α=2.9°.

### 1) Initial Magnetization Step

Initial magnetization was performed on the perpendicular magnetic recording medium. The applied magnetic field was a perpendicular magnetic field perpendicular to the disk surface of the perpendicular magnetic recording medium with strength of 10 kOe.

### 2) Contacting Step

The master carrier was placed opposite to the perpendicular magnetic recording medium subjected to the initial magnetization and they were brought into close contact with each other by a pressure of 1.5 MPa for 30 seconds.

### 3) Transfer Magnetic Application Step

A transfer magnetic field was applied to the contact body. A conductor wire with a diameter of 10 mm was disposed in a central portion of the holder and a current is applied, whereby a circumferential magnetic filed having strength varied like a single pulse (pulse magnetic field) was generated as the transfer magnetic field. The strength of the transfer magnetic field was 4.6 kOe at the innermost circumference of the servo signal (radius: 10 mm). The transfer magnetic field application time (time duration of single pulse like magnetic field) was 0.0125 ms.

### 4) Separation Step

After completing the transfer magnetic field application, the master carrier was separated from the perpendicular magnetic recording medium.

### Example 2

A magnetic transfer method of Example 2 was performed in the same manner as in Example 1 other than using a master carrier having a pattern shape with α=3.7°.

### Example 3

A magnetic transfer method of Example 2 was performed in the same manner as in Example 1 other than using a master carrier having a pattern shape with α=4.7°.

### Examples 4 to 8

Magnetic transfer methods of Examples 4 to 8 were performed in the same manner as in Example 1 other than using a master carrier having a pattern shape with α=3.7° as in Example 2 with transfer magnetic field application times (time durations of single pulse like magnetic fields) shown in Table 1.

### Examples 9 to 11

Magnetic transfer methods of Examples 9 to 11 were performed in the same manner as in Example 1 other than with transfer magnetic application times shown in Table 1.

### Comparative Examples 1 to 4

Magnetic transfer methods of Comparative Examples 1 to 4 were performed in the same manner as in Example 1 other than with transfer magnetic application times shown in Table 1 which are outside of the scope of the present invention (values greater than 100 ms).

### Comparative Example 5

A magnetic transfer method of Comparative Example 5 was performed in the same manner as in Example 1 other than applying a DC magnetic field. The term “DC magnetic field” as used herein refers to a case in which a maximum transfer magnetic field is applied to the same area for not less than one second. The DC magnetic field was applied using annular electromagnet 60 shown in FIG. 13. The time from the start magnetic field to the maximum transfer magnetic field and the time from the maximum transfer magnetic field to the end magnetic field were about 0.5 seconds respectively, and the maximum transfer magnetic field was applied to the stacked body for about 4 seconds.

### Comparative Example 6

A magnetic transfer method of Comparative Example 6 was performed in the same manner as in Example 7 other than using a master carrier having a pattern shape with α=5.5°.

### Comparative Example 7

A magnetic transfer method of Comparative Example 7 was performed in the same manner as in Comparative Example 5 other than using a master carrier having a pattern shape with α=5.5°. That is, also in Comparative Example 7, the DC magnetic field was applied as the transfer magnetic field.

### (Signal Evaluation)

Qualities of servo signals reproduced from magnetic recording media subjected to the magnetic transfer by the magnetic transfer methods of Examples and Comparative Examples based on the amplitude uniformity (PRSIGMA) and measurement of servo PES. α of master carrier of each Example and Comparative Example and evaluation are shown in Table 1 below.

### <PRSIGMA Measurement>

A waveform of the preamble section was detected from each perpendicular magnetic recording medium subjected to the magnetic transfer. An evaluator having a GMR head with a read width of 110 nm and a write width of 180 nm (LS-90, Kyodo Electronics, Inc.) was used for the waveform detection. An area defined by radii of 20 and 32 mm was measured at an interval of 1 mm, the overall averages (PRAM) of magnetic flux suction side signals and magnetic flux ejection side signals of the magnetized areas formed according to edges of convex portions by the application of a horizontal magnetic field were calculated, a deviation from the average value (PRSIGMA=3σ/PRAM (%)) was measured as an indicator of the amplitude uniformity at each radial position. The term “magnetic flux suction side signals” as used herein refers to pulse signals from areas 12a shown in FIG. 7 formed according to edge portions and magnetized in the suction direction of the magnetic flux, and the term “magnetic flux ejection side signals” as used herein refers to pulse signals from areas 12b shown in FIG. 7 formed according to edge portions and magnetized in the ejection direction of the magnetic flux. Here, a magnetic recording medium was rated good (∘) if it has less than five sectors with a PRSIGMA value greater than or equal to 20%, usable (▴) if it has five to nine sectors with a PRSIGMA value greater than or equal to 20%, and no good (x) if it has ten or more sectors with a PRSIGMA value greater than or equal to 20%. Note that the areas evaluated as ∘ and ▴ are usable areas.

### <Servo PES>

Servo PES (position error signal) was also evaluated. An evaluator available from IMES Co., Ltd (BitFinder) was used for the evaluation. The head in VCM mode was mounted and servo following was evaluated. In a servo following state, PES was measured. Standard deviation (σ) was obtained from PES measurement values of each sector for 50 circumferences, and a magnetic recording medium was rated good (∘) if PES value is less than 15% of the track pitch (TP) at 3σ, usable (▴) if the value is from 15% to less than 25%, and no good (x) if the value is greater than or equal to 25%.

TABLE 1

| | Rectangle | Magnetic | | | | |
|---|---|---|---|---|---|---|
| | Side | Field App. | | | | |
| | Inclination | time | PRSIGMA | | PES | |
| | α (°) | (ms) | (number) | Eva. | (%) | Eva. |
| Exam. 1 | 2.9 | 0.0125 | 1 | ◯ | 5 | ◯ |
| Exam. 2 | 3.7 | 0.0125 | 3 | ◯ | 7 | ◯ |
| Exam. 3 | 4.7 | 0.0125 | 4 | ◯ | 12 | ◯ |
| Exam. 4 | 3.7 | 0.05 | 7 | ▴ | 16 | ▴ |
| Exam. 5 | 3.7 | 0.0083 | 7 | ▴ | 18 | ▴ |
| Exam. 6 | 3.7 | 0.025 | 7 | ▴ | 13 | ▴ |
| Exam. 7 | 3.7 | 0.01 | 6 | ▴ | 14 | ▴ |
| Exam. 8 | 3.7 | 0.0077 | 9 | ▴ | 15 | ▴ |
| Exam. 9 | 2.9 | 50 | 6 | ▴ | 16 | ▴ |
| Exam. 10 | 2.9 | 80 | 7 | ▴ | 18 | ▴ |
| Exam. 11 | 2.9 | 90 | 8 | ▴ | 21 | ▴ |
| Com. Exam. | 2.9 | 120 | 12 | X | 26 | X |
| 1 | | | | | | |
| Com. Exam. | 2.9 | 150 | 14 | X | 27 | X |
| 2 | | | | | | |
| Com. Exam. | 2.9 | 500 | 14 | X | 28 | X |
| 3 | | | | | | |
| Com. Exam. | 2.9 | 1000 | 15 | X | 28 | X |
| 4 | | | | | | |
| Com. Exam. | 2.9 | 5000 | 15 | X | 29 | X |
| 5 | | | | | | |
| Com. Exam. | 5.5 | 0.01 | 12 | X | 35 | X |
| 6 | | | | | | |
| Com. Exam. | 5.5 | 5000 | 23 | X | 30 | X |
| 7 | | | | | | |

As illustrated in Table 1, the evaluation results show that magnetic recording media obtained by magnetic transfer methods of the present invention (Examples 1 to 11) using magnetic transfer master carriers having values of α not greater than 5° have high amplitude uniformity in PRSIGMA measurements and smaller standard deviations in PES measurements in servo following, resulting in a high quality of a reproduced signal in comparison with magnetic recording media obtained by Comparative Examples 1 to 7 outside of the magnetic transfer methods of the present invention.

Further, from the evaluation results of Examples 1 to 11 and Comparative Example 6 in which a master carrier having a pattern shape with α greater than 5° was used, it can be said that the inclination of the pattern shape is preferable to be not greater than 5°. Further, the results show that the transfer method of Example 1 using a master carrier with a smallest value of α among those listed in Table 1 may provide a magnetic recording medium capable of reproducing a highest quality signal. Thus, a smaller inclination is desirable, and it is thought that 3° or less is preferable.

Still further, from Examples 1 to 11 and Comparative Examples 1 to 5, it has become clear that a high accurate magnetic transfer can be performed by using a master carrier having a pattern shape inclination of not greater than 5° and applying a single short pulse like circumferential magnetic field of not greater than 100 ms, whereby a high quality reproduced signal can be obtained. In particular, the results show that a highest transfer signal quality can be obtained for a perpendicular magnetic recording medium used as a medium that receives magnetic transfer when application time of a single pulse like circumferential magnetic field (transfer magnetic field) is 0.0125 ms. It is thought that the magnetic field application time depends largely on the magnetic properties of the magnetic layer of a perpendicular magnetic recording medium. Therefore, it is thought that the optimum magnetic filed application time may change if a medium different from the perpendicular magnetic recording media used in Examples is used as the medium that receives magnetic transfer.

What is claimed is:

1. A magnetic transfer method for transferring a transfer pattern, which is designed for transferring desired information to a perpendicular magnetic recording medium for use in a recording/reproducing device having a rotary read/write head for scanning a disk in an arc shape intersecting concentric tracks, provided on a surface of a magnetic transfer master carrier to a perpendicular magnetic recording medium by applying a magnetic field to a stacked body of the magnetic transfer master carrier and the perpendicular magnetic recording medium tightly stacked on top of each other such that a central portion of the transfer pattern is aligned with a central portion of the perpendicular magnetic recording medium, wherein:
the transfer pattern is constituted by multiple fine elements and each element has a planar shape formed of a plurality of rectangles, each having two sides parallel to a circumferential tangent line and two sides forming an angle of 90±5° with the circumferential tangent line, arranged continuously in a track width direction in each concentrically provided track, and a side of the planar shape of each element intersecting the circumferential tangent line has an effective inclination corresponding to a skew angle of the read/write head in each track; and
the magnetic field is a circumferential magnetic field concentric to the stacked body, varied in strength like a single pulse from a start magnetic field smaller than a magnetization reversal magnetic field of the perpendicular magnetic recording medium to a maximum transfer magnetic field and then to an end magnetic field smaller than the magnetization reversal magnetic field, and applied to the stacked body such that the time from the start magnetic field to the end magnetic field does not exceed 100 ms.

2. The magnetic transfer method of claim 1, wherein the circumferential magnetic field is generated by an annular electromagnet disposed on at least one surface of the stacked body.

3. The magnetic transfer method of claim 1, wherein:
as the magnetic transfer master carrier and the perpendicular magnetic recording medium, those having center holes are used and the stacked body is formed by aligning the center holes; and
the circumferential magnetic field is generated by applying a current in a center hole of the stacked body in an axis direction substantially perpendicular to the stacked body.

4. The magnetic transfer method of claim 1, wherein each of the rectangles of the magnetic transfer master carrier has a length in the track width direction corresponding to 1/N of the track width and each of the elements is formed by arranging N rectangles in the track width direction.

5. The magnetic transfer method of claim 1, wherein the desired information is servo information.

6. A magnetic transfer master carrier having a transfer pattern on a surface for transferring desired information to a perpendicular magnetic recording medium for use in a recording/reproducing device having a rotary read/write head for scanning a disk in an arc shape intersecting concentric tracks,
wherein the transfer pattern is constituted by multiple fine elements and each element has a planar shape formed of a plurality of rectangles, each having two sides parallel to a circumferential tangent line and two sides respectively forming an angle of 90±5° with the circumferential tangent line, arranged continuously in a track width direction in each of concentrically provided tracks, and a side of the planar shape of each element intersecting the circumferential tangent line has an effective inclination corresponding to a skew angle of the read/write head in each track.

7. The magnetic transfer master carrier of claim 6, wherein each of the rectangles has a length in the track width direction corresponding to 1/N of the track width and each of the elements is formed by arranging N rectangles in the track width direction.

8. The magnetic transfer master carrier of claim 6, wherein the desired information is servo information.
